(19) United States
(12) Patent Application Publication
(10) Pub. No.: US 2026/0063846 A1
(43) Pub. Date: Mar. 5, 2026

(54) METHOD FOR PRODUCING SELF-FORMING OPTICAL WAVEGUIDE

(71) Applicant: ORBRAY CO., LTD, Tokyo (JP)

(72) Inventor: Tsuyoshi NAMEKAWA, Tokyo (JP)

(73) Assignee: ORBRAY CO., LTD, Tokyo (JP)

(21) Appl. No.: 19/106,114

(22) PCT Filed: Aug. 30, 2023
(86) PCT No.: PCT/JP2023/031358

§ 371 Date: Feb. 24, 2025

(30) Foreign Application Priority Data
Aug. 31, 2022 (JP) 2022-137683

(51) Int. Cl. G02B 6/255; B29D 11/00; G02B 6/02

(52) U.S. Cl. CPC G02B 6/255; B29D 11/00663; G02B 6/02033; G02B 6/02042

(57) ABSTRACT

Manufacturing a self-forming optical waveguide from a photocurable resin and two multicore fibers each having n cores (n: a natural number≥2). The photocurable resin includes a core part forming resin polymerizable by incident light and has a refractive index na after curing, and a cladding part forming resin polymerizable and curable by incident light of an intensity≥the intensity of the light incident on the core part forming resin and has a refractive index nb after curing satisfying nb<na. The two multicore fibers face each other and the photocurable resin is positioned between them. Light incident on the photocurable resin originating from the cores of the two multicore fibers forms the core parts. Next, light incident on the core parts generates light leakage into the cladding part forming resin and polymerizes and cures the cladding part forming resin around the core parts.

### CROSS-REFERENCE TO RELATED APPLICATIONS

This application claims priority to Japanese Patent Application No. 2022-137683 filed on Aug. 31, 2022, which is expressly incorporated herein by reference in its entirety.

### TECHNICAL FIELD

The present invention relates to a method of manufacturing a self-forming optical waveguide.

### BACKGROUND ART

Advances in the field of optical communication, optical information processing, electronic equipment, optical equipment, and the like using optical technology created a need for the development of optical waveguides to be used between various optical devices. Various optical devices are optically connected by optical waveguides such as optical fibers, but the connection requires extremely high positional accuracy. Conventionally, such connection work has been performed manually or using high-precision alignment equipment, which has led to a problem of increased connection costs.

In order to solve such a problem, a self-forming optical waveguide has been developed. A self-forming optical waveguide is an optical waveguide in which the core of the optical waveguide is self-formed from a photocurable resin. A self-forming optical waveguide can be formed at the end of an optical fiber or the like by immersing the end of an optical fiber or the like in the photocurable resin and gradually curing the photocurable resin by irradiating the photocurable resin with light from the optical fiber or the like.

Regarding self-forming optical waveguides, for example, the optical connector described in Patent Literature 1, which is expressly incorporated herein by reference in its entirety, includes at least a ferrule and n (n: natural number not including 0) self-forming optical waveguides. The ferrule has n optical fiber insertion holes, and optical fibers each inserted into a respective optical fiber insertion hole. Furthermore, after the optical waveguide is formed, it is allowed to stand for two minutes to promote interdiffusion of monomers at the boundary surface between a core and a cladding, and then the cladding is formed by UV irradiation. In the core region, only one monomer of the photocurable resin is consumed and polymerized, so a concentration gradient of the monomer occurs at the boundary surface between the core and the cladding, and interdiffusion progresses, fulfilling the function of the cladding. In addition, by irradiating the entire photocurable resin with UV light, the entire core and cladding are cured and formed, and an optical waveguide is obtained.
Patent Literature 1: WO 2020/209364

### SUMMARY OF INVENTION

However, when attempting to form multiple self-forming optical waveguides as described in Patent Literature 1, when the entire photocurable resin is irradiated with UV light, the entire photocurable resin undergoes cure shrinkage. This cure shrinkage generates stress throughout the photocurable resin, leading to deformation of the core of the self-forming optical waveguide. This deformation leads to deterioration of optical insertion loss in the core.

Furthermore, when the entire photocurable resin is irradiated with UV light, depending on the UV irradiation angle, the core on the lower side with respect to the UV light source may be hindered from UV irradiation by the core on the upper side, and sufficient UV irradiation may not be obtained, resulting in the formation of a self-forming optical waveguide with incomplete curing of the cladding. This effect also causes deterioration of the optical insertion loss for each core.

One aspect of the present invention provides a method of manufacturing a self-forming optical waveguide that can prevent the deterioration of optical insertion loss in the core part of the self-forming optical waveguide.

One aspect of the present invention relates to a method of manufacturing a self-forming optical waveguide. The manufacturing method includes preparing a photocurable resin and two multicore fibers each having at least n cores (n: a natural number of 2 or more), the photocurable resin including a core part forming resin that is polymerized when light in a predetermined wavelength band is incident thereon and has a refractive index na after curing, and a cladding part forming resin that is polymerized and cured when light of an intensity equal to or greater than that of the light incident on the core part forming resin is incident thereon and has a refractive index nb after curing satisfying nb<na, and also includes arranging the two multicore fibers to face each other and arranging the photocurable resin between the multicore fibers, making light of an intensity allowing only the core part forming resin to be polymerized incident on the photocurable resin from the cores of the two multicore fibers to cause polymerization and curing of the core part forming resin, thereby forming core parts of optical waveguides within the photocurable resin, and after the core parts are formed, causing interdiffusion of monomers in the cladding part forming resin around the core parts, next making light incident on, and causing propagation thereof in, the core parts, generating light leakage into the uncured cladding part forming resin around the core parts, and polymerizing and curing the cladding part forming resin around the core parts by the leakage light to form the cladding parts, thereby self-forming n optical waveguides in the photocurable resin.

In accordance with the method of manufacturing a self-forming optical waveguide according to one aspect of the present invention, by forming the cladding parts by the light leakage from the core parts, it is possible to prevent the occurrence of cure shrinkage of the entire photocurable resin except for the core parts, and it is possible to limit the resin that cures when forming the cladding parts to only the cladding part forming resin. Therefore, it is possible to prevent the occurrence of stress in the entire photocurable resin, the deformation of the core parts can be suppressed, and the deterioration of the optical insertion loss in the core parts can be suppressed.

Furthermore, in accordance with the method of manufacturing a self-forming optical waveguide according to one aspect of the present invention, a plurality of self-forming optical waveguides can be formed without irradiation with UV light from around the photocurable resin when forming the cladding parts, so that the curing of all cladding parts can be completed, and the deterioration of the optical insertion loss for each core part can be prevented.

### BRIEF DESCRIPTION OF DRAWINGS

FIG. 1 is a front view showing the configuration of a multicore fiber used in the method of manufacturing a self-forming optical waveguide according to an example of the present invention.

FIG. 2 is a partial explanatory drawing illustrating a state after a photocurable resin was placed between two multicore fibers in the method of manufacturing a self-forming optical waveguide according to an example of the present invention.

FIG. 3 is an explanatory drawing illustrating a state after light was made incident from the cores of the two multicore fibers into the photocurable resin and the core parts of the self-forming optical waveguide were formed from the state in FIG. 2.

FIG. 4 is a perspective view in which the photocurable resin and the transparent container were removed from the state in FIG. 3.

FIG. 5 is an explanatory drawing illustrating a state after light was made incident on, and caused to propagate in, the core parts, and leakage light was generated from the core parts from the state in FIG. 3.

FIG. 6 is an explanatory drawing illustrating a state after each cladding part and a plurality of self-forming optical waveguides were formed from the state in FIG. 5.

FIG. 7 is a stereomicroscope observation image showing the state in FIG. 6.

### DESCRIPTION OF EMBODIMENTS

The manufacturing method includes preparing a photocurable resin and two multicore fibers each having at least n cores (n: a natural number of 2 or more), the photocurable resin including a core part forming resin that is polymerized when light in a predetermined wavelength band is incident thereon and has a refractive index na after curing, and a cladding part forming resin that is polymerized and cured when light of an intensity equal to or greater than that of the light incident on the core part forming resin is incident thereon and has a refractive index nb after curing satisfying nb<na, and also includes arranging the two multicore fibers to face each other, arranging the photocurable resin between the multicore fibers, making light of an intensity allowing only the core part forming resin to be polymerized incident on the photocurable resin from the cores of the two multicore fibers to cause polymerization and curing of the core part forming resin, thereby forming core parts of optical waveguides within the photocurable resin, and after the core parts are formed, causing interdiffusion of monomers in the cladding part forming resin around the core parts, next making light incident on, and causing propagation thereof in, the core parts, generating light leakage into the uncured cladding part forming resin around the core parts, and polymerizing and curing the cladding part forming resin around the core parts by the leakage light to form the cladding parts, thereby self-forming n optical waveguides in the photocurable resin.

In accordance with the manufacturing method, by forming the cladding parts by the light leakage from the core parts, it is possible to prevent the occurrence of cure shrinkage of the entire photocurable resin except for the core parts, and it is possible to limit the resin that cures when forming the cladding parts to only the cladding part forming resin. Therefore, it is possible to prevent the occurrence of stress in the entire photocurable resin, the deformation of the core parts can be suppressed, and the deterioration of the optical insertion loss in the core parts can be suppressed.

Furthermore, in accordance with the manufacturing method, a plurality of self-forming optical waveguides can be formed without irradiation with UV light from around the photocurable resin when forming the cladding parts, so that the curing of all cladding parts can be completed, and the deterioration of the optical insertion loss for each core part can be prevented.

In one embodiment of the manufacturing method, the light is made incident on the core parts simultaneously from the cores.

By simultaneously making the light incident from all the cores of the multicore fibers into all the core parts, complicated incidence time control is made unnecessary and the time required to form the cladding parts can be shortened.

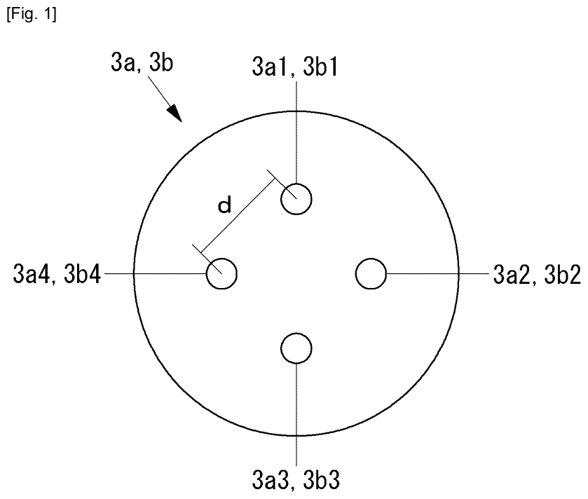

Below, as an example of the present invention, a manufacturing method according to the example will be described with reference to FIGS. 1 to 7, but the present invention is not limited to the following example.

### EXAMPLE

In the manufacturing method of the present example, first, a photocurable resin 1 and multicore fibers (3a, 3b) having at least n cores (n: natural number of 2 or more) are prepared. Two multicore fibers (3a, 3b) with the same structure are prepared. n is a natural number of 2 or more, for example, 2 to 4. However, n is not limited to the range exemplified here.

A transparent container 4 is filled with the photocurable resin 1, and one end of each multicore fiber (3a, 3b) is immersed in the photocurable resin 1. Therefore, the photocurable resin 1 is arranged between the multicore fibers (3a, 3b), and the two multicore fibers (3a, 3b) are arranged to face each other with the photocurable resin 1 sandwiched therebetween.

Each of the two multicore fibers (3a, 3b) has a circular outer shape as shown in FIG. 1, a core diameter of 8.0 μm, and a cladding diameter of 125 μm, and also includes n=4 cores (3a1, 3a2, 3a3, 3a4, or 3b1, 3b2, 3b3, 3b4). In addition, the four cores (3a1 to 3a4, or 3b1 to 3b4) are disposed in 2 rows×2 cores at equal angles (90° in FIG. 1) and equal intervals on the circumference of a circle centered on the center of the multicore fiber (3a, 3b), as shown in FIG. 1. In the multicore fibers (3a, 3b), the interval d between the cores (3a1 to 3a4, or 3b1 to 3b4) is 50 μm. The interval d is the distance between the centers of two cores.

For example, the cutoff wavelength is 1300 nm to 1500 nm, and the mode field diameter is 7.4 μm to 8.5 μm (propagating light wavelength 1550 nm).

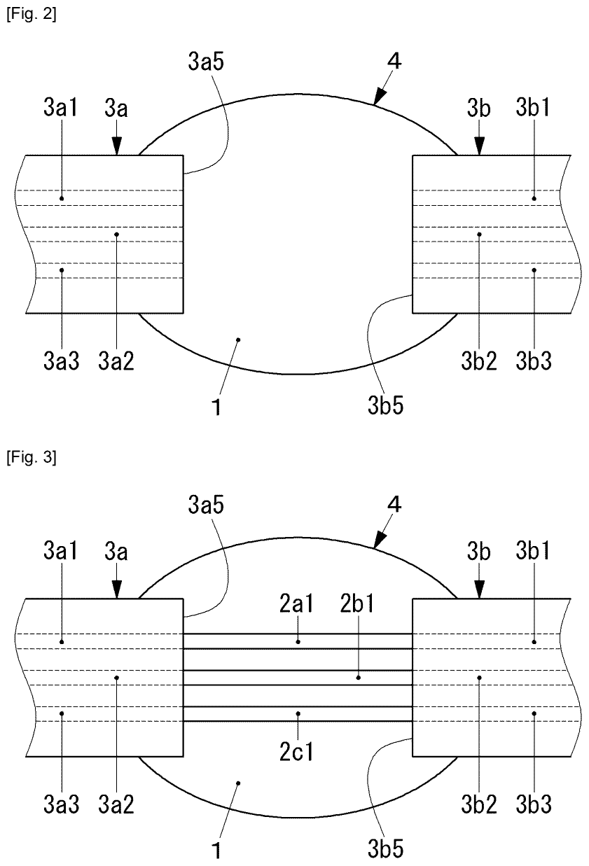

The end faces (3a5, 3b5) of the multicore fibers (3a, 3b) immersed in the photocurable resin 1 are formed to have a planar shape perpendicular to the optical axis direction of the cores (3a1 to 3a4, or 3b1 to 3b4) as shown in FIG. 2. The end faces (3a5, 3b5) are subjected to flat surface polishing. The flat surface processing can be performed by a known method capable of flat surface processing, such as polishing, laser cutting, cleave cutting, and the like.

The photocurable resin 1 includes a core part forming resin and a cladding part forming resin. The core part forming resin has a refractive index na as a result of being polymerized and cured by light of a predetermined wavelength band incident thereon. The cladding part forming resin is polymerized and cured by light of the same or different wavelength band as the light incident on the core part forming resin and of an intensity equal to or greater than that of the light incident on the core part forming resin. Furthermore, the refractive index nb of the cladding part forming resin after curing satisfies nb<na.

The core part forming resin and the cladding part forming resin are selected from photocurable resins that are photopolymerized through different polymerization reactions. In the present example, the photocurable resin 1 for forming the core parts is an acrylic resin, and the photocurable resin 1 for forming the cladding parts is an epoxy resin. In the combination of an acrylic resin and an epoxy resin, the polymerization reaction rate of the acrylic resin is faster than that of the epoxy resin, so only the acrylic resin can be selectively polymerized by light of low intensity.

In the present invention and present specification, the term “photocurable resin” refers to a composition that can form a polymer (homopolymer or copolymer) by photocuring. Such a composition can be, for example, a composition containing one, or two or more types of polymerizable compounds and a photopolymerization initiator. For example, an acrylic resin and an epoxy resin can be solutions in which a photopolymerization initiator is added to a mixed liquid containing two or more types of polymerizable compounds. Hereinafter, the polymerizable compound is also referred to as a “monomer.” A polymerizable compound is a compound having a polymerizable group, is not limited to a monomer, and is inclusive of oligomers and prepolymers as well.

Next, light of a predetermined wavelength band is made incident on the inside of the photocurable resin 1 from the cores (3a1 to 3a4, or 3b1 to 3b4) of the two multicore fibers (3a, 3b). The light incident on the photocurable resin 1 is laser light of an intensity that allows polymerization of only the core part forming resin. The wavelength Aw of the light can be freely set depending on the photopolymerization initiator, and one example is 365 nm to 1675 nm, and in the present example, Aw is set to 405 nm. In addition, the wavelength band to which the photopolymerization initiator is sensitive is also set to around 405 nm.

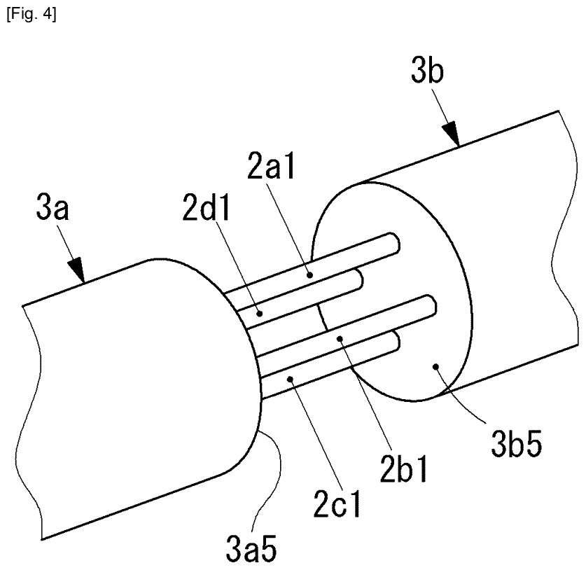

The incidence of light from the cores (3a1 to 3a4, or 3b1 to 3b4) causes polymerization and curing of the core part forming resin, the monomers of the core part forming resin form a polymer, and a plurality of core parts (2a1, 2b1, 2c1, 2d1) of the optical waveguide shown in FIGS. 3 and 4 are self-formed within the photocurable resin 1.

The diameter of the core parts (2a1, 2b1, 2c1, 2d1) is preferably the same as the diameter of the cores (3a1 to 3a4, or 3b1 to 3b4) of the multicore fibers (3a, 3b), and it is also preferable that each core part (2a1, 2b1, 2c1, 2d1) has a uniform diameter in the optical axis direction. Furthermore, the mode field diameter of the core parts (2a1, 2b1, 2c1, 2d1) is set to be the same (7.4 μm to 8.5 μm) as the mode field diameter of the cores (3a1 to 3a4, or 3b1 to 3b4) of the multicore fibers (3a, 3b).

Next, the self-forming of the cladding parts will be explained. After the core parts (2a1, 2b1, 2c1, 2d1) are formed, the interdiffusion of monomers is generated in the cladding part forming resin in the photocurable resin 1 around the core parts (2a1, 2b1, 2c1, 2d1) (the boundary surface between the core parts 2a1, 2b1, 2c1, 2d1 and the other portions of the photocurable resins 1). While the monomers are consumed and polymerized in the region of the core parts (2a1, 2b1, 2c1, 2d1), the monomers in the photocurable resin 1 other than the core parts (2a1, 2b1, 2c1, 2d1) are not polymerized and are uncured and unconsumed, so a concentration gradient of the monomers occurs around the core parts (2a1, 2b1, 2c1, 2d1), and interdiffusion progresses. In the present example, after the formation of the core parts (2a1, 2b1, 2c1, 2d1), the configuration was allowed to stand for two minutes to promote interdiffusion of the monomers.

Next, in the present example, laser light of the same wavelength band (λw=405 nm) as the wavelength band in which the core part forming resin is polymerized is made incident on the core parts (2a1, 2b1, 2c1, 2d1) from the cores (3a1 to 3a4, or 3b1 to 3b4) of the multicore fibers (3a, 3b) and caused to propagate inside the core parts (2a1, 2b1, 2c1, 2d1). Light with an intensity equal to or greater than that of the light that polymerized the core part forming resin is made incident on the core parts (2a1, 2b1, 2c1, 2d1). Of course, this intensity is set to allow the polymerization of the cladding part forming resin.

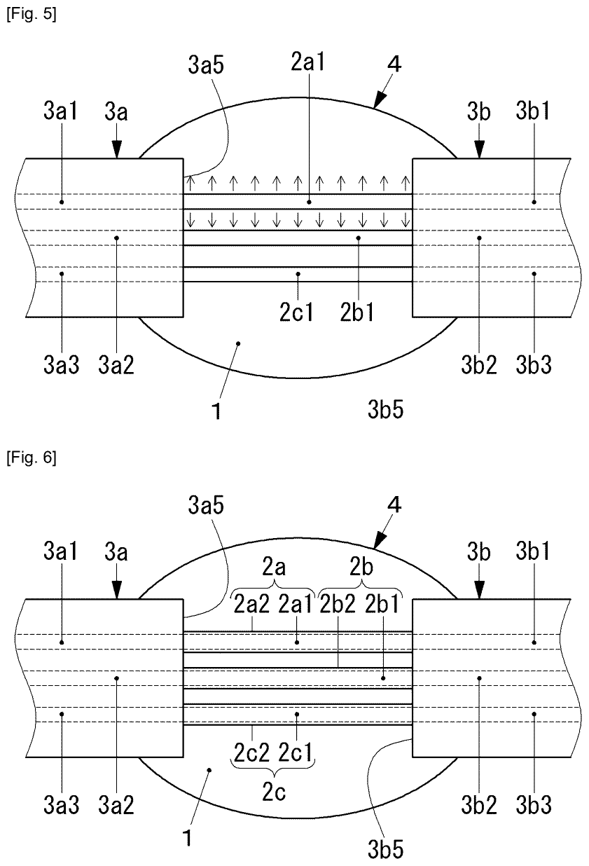

The propagation of light is further continued, causing light leakage from the core parts (2a1, 2b1, 2c1, 2d1) to the uncured cladding part forming resin surrounding the core parts (2a1, 2b1, 2c1, 2d1). The cladding part forming resin surrounding the core parts (2a1, 2b1, 2c1, 2d1) is then polymerized and cured by the leakage light shown by the arrows in FIG. 5, and the cladding parts (2a2, 2b2, 2c2, 2d2) are self-formed in a form that surrounds the surface of the core parts (2a1, 2b1, 2c1, 2d1). The arrows in FIG. 5 are only shown for one core part 2a1, but light leakage also occurs in the other core parts (2b1, 2c1, 2d1). Although the cladding part 2d2 is not shown, it is a self-formed cladding part that surrounds the surface of the core 2d1.

The refractive index nb of the self-formed cladding parts (2a2, 2b2, 2c2, 2d2) after curing satisfies nb<na, where na is the refractive index of the core parts (2a1, 2b1, 2c1, 2d1). Thus, a plurality of self-formed optical waveguides (2a, 2b, 2c, 2d) is self-formed by the core parts (2a1, 2b1, 2c1, 2d1) and cladding parts (2a2, 2b2, 2c2, 2d2). The self-formed optical waveguide 2a consists of the core part 2a1 and the cladding part 2a2. Furthermore, the self-formed optical waveguide 2b consists of the core part 2b1 and the cladding part 2b2, the self-formed optical waveguide 2c consists of the core part 2c1 and the cladding part 2c2, and the self-formed optical waveguide 2d consists of the core part 2d1 and the cladding part 2d2.

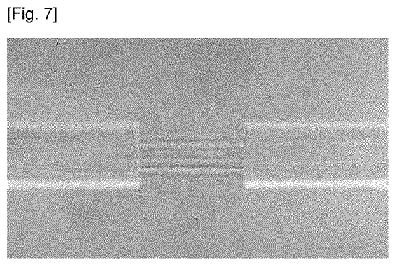

Finally, ultraviolet (UV) light is uniformly radiated from around the transparent container 4 to cure all of the unreacted photocurable resin 1 (see FIGS. 6 and 7).

The light for forming the cladding parts (2a2, 2b2, 2c2, 2d2) may be made incident on all of the core parts (2a1, 2b1, 2c1, 2d1) simultaneously from all of the cores (3a1 to 3a4, or 3b1 to 3b4) of the multicore fibers (3a, 3b), or may be incident on each core part (2a1, 2b1, 2c1, 2d1) one by one in sequence. By making the light for forming the cladding parts incident on all of the core parts (2a1, 2b1, 2c1, 2d1) simultaneously from all of the cores (3a1 to 3a4, or 3b1 to 3b4) is preferable because complicated incidence time control is made unnecessary and the time required to form the cladding parts (2a2, 2b2, 2c2, 2d2) can be shortened.

As described above, by forming the cladding parts (2a2, 2b2, 2c2, 2d2) using light leakage from the core parts (2a1, 2b1, 2c1, 2d1), it is possible to prevent the occurrence of cure shrinkage of the entire photocurable resin 1 except for the core parts (2a1, 2b1, 2c1, 2d1), and it is possible to limit the resin that cures when forming the cladding parts (2a2, 2b2, 2c2, 2d2) to the cladding part forming resin. Therefore, it is possible to prevent the occurrence of stress in the entire photocurable resin 1, deformation of the core parts (2a1, 2b1, 2c1, 2d1) can be suppressed, and the deterioration of the optical insertion loss in the core parts (2a1, 2b1, 2c1, 2d1) can be suppressed.

Furthermore, by forming the cladding parts (2a2, 2b2, 2c2, 2d2) using leakage light as described above, it becomes possible to control the diameter and thickness of each cladding part, and it is also possible to stabilize the optical and mechanical properties of the self-formed optical waveguides (2a, 2b, 2c, 2d).

Furthermore, when forming a plurality of self-forming optical waveguides (2a, 2b, 2c, 2d) as in the present example, by completing the curing of all the cladding parts (2a2, 2b2, 2c2, 2d2) without irradiation with UV light from around the photocurable resin 1 when forming the cladding parts (2a2, 2b2, 2c2, 2d2), it is possible to prevent the deterioration of the optical insertion loss for each core part (2a1, 2b1, 2c1, 2d1).

After forming the self-forming optical waveguides (2a, 2b, 2c, 2d), light with a wavelength of 1550 nm was made incident from each core (3a1 to 3a4) of the multicore fiber 3a and caused to propagate in each optical waveguide (2a, 2b, 2c, 2d), the optical output of the emitted light relative to the optical output of the incident light was measured with a power meter, and the optical insertion loss between the multicore fibers (3a, 3b) was measured.

The loss values are shown in Table 1. As shown in Table 1, it was confirmed that the optical insertion loss was improved to within the range of 0.2 dB to 1.2 dB in all four optical waveguides (2a, 2b, 2c, 2d). In Table 1, the optical waveguide 2a is shown as a channel 1, the optical waveguide 2b as a channel 2, the optical waveguide 2c as a channel 3, and the optical waveguide 2d as a channel 4. The length of each optical waveguide (2a, 2b, 2c, 2d) between the end faces (3a5, 3b5) of the two multicore fibers (3a, 3b) is 500 μm.

TABLE 1

| Channel | Optical insertion loss (dB) |
|---|---|
| 1 | 0.8 |
| 2 | 1.0 |
| 3 | 0.2 |
| 4 | 1.2 |

The present invention is applicable not only to the method of manufacturing self-forming optical waveguides between multicore fibers, but also to the field of high-density optical packaging, such as methods of manufacturing self-forming optical waveguides between multicore fibers and silicon optical waveguides, or between multicore optical fibers and polymer optical waveguides.

### REFERENCE SIGNS LIST

1 Photocurable resin
2a, 2b, 2c, 2d Self-forming optical waveguide
2a1, 2b1, 2c1, 2d1 Core part of self-forming optical waveguide
2a2, 2b2, 2c2, 2d2 Cladding part of self-forming optical waveguide
3a, 3b Multicore fiber
3a1, 3a2, 3a3, 3a4, 3b1, 3b2, 3b3, 3b4 Core of multicore fiber
3a5, 3b5 End face of multicore fiber
4 Transparent container
d Spacing between cores of multicore fiber

1. A method of manufacturing a self-forming optical waveguide, comprising:
preparing a photocurable resin and two multicore fibers each having at least n cores (n: a natural number of 2 or more), the photocurable resin comprising a core part forming resin that is polymerized when light in a predetermined wavelength band is incident thereon and has a refractive index na after curing, and a cladding part forming resin that is polymerized and cured when light of an intensity equal to or greater than that of the light incident on the core part forming resin is incident thereon and has a refractive index nb after curing satisfying nb<na,
arranging the two multicore fibers to face each other and arranging the photocurable resin between the multicore fibers,
making light of an intensity allowing only the core part forming resin to be polymerized incident on the photocurable resin from the cores of the two multicore fibers to cause polymerization and curing of the core part forming resin, thereby forming core parts of optical waveguides within the photocurable resin,
after the core parts are formed, causing interdiffusion of monomers in the cladding part forming resin around the core parts,
next making light incident on, and causing propagation thereof in, the core parts, generating light leakage into the cladding part forming resin, that is uncured, around the core parts, and polymerizing and curing the cladding part forming resin around the core parts by the leakage light to form cladding parts, thereby self-forming n optical waveguides in the photocurable resin.

2. The method of manufacturing a self-forming optical waveguide according to claim 1,
wherein the light is made incident on the core parts simultaneously from the cores.
